(19) United States
(12) Patent Application Publication
(10) Pub. No.: US 2003/0055593 A1
(43) Pub. Date: Mar. 20, 2003

(54) Method for user variation of a measurement process

(76) Inventors: Ed O. Schlotzhauer, St Loveland, CO (US); Gary W. Beyer, Spokane, WA (US); Tammy Jo Risa, Kalispell, MT (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 09/955,796

(22) Filed: Sep. 18, 2001

(51) Int. Cl. G06M 11/04

(52) U.S. Cl. 702/127

(57) ABSTRACT

A method by which a user can modify or interact with a computer controlled measurement process at one or more specified points within the code controlling the process. These points are called variation points and are inserted by the designer at points in the code where a designer anticipates that a user may want to interact with or modify the process. In operation, when a variation point is reached, control passes to a user-defined process or subsystem. The user-defined subsystem performs one or more actions, including modification of measurement data, control of a device being tested and variation of numerical and control parameters defining the measurement process. Control may then be passed back to the measurement process. Subsequent operations performed by the measurement process may be affected through the numerical and control parameters.

### FIELD OF THE INVENTION

This invention relates to the field of software control of a measurement process and in particular to a method for allowing a user of the measurement process to modify the process.

### BACKGROUND OF THE INVENTION

Many measurement systems and processes are controlled by software running on a computer. Some tasks, called standard tasks, performed by a measurement system may be common to many users, so software to perform those tasks is often supplied with the measurement system, or by a third party vendor. Other tasks may be highly complex but, if they are to be repeated many times, considerable effort may be invested in producing the software. The software may be supplied as source code or as executable code. Often, however, a user may need to perform a task that is a variation of a standard task. For example, the user may wish to modify selective behavior of the process, modify data at selected points within the process, or add additional functionality to the process. The user may be a person or a machine.

Adding this flexibility to a commercial measurement system involves direct and indirect costs to the producer of the system. For example, proprietary knowledge of the measurement process will be revealed if source code or detailed documentation is provided the user. Production and distribution of documentation adds a direct cost, as does the provision of technical support. There is an increased need for technical support if the user is required to understand all parts of a complex measurement process. Further, if the user is permitted to modify the measurement process without sufficient safeguards, the process may be invalidated. This increases the need for technical support and may also make the user dissatisfied with the measurement system.

Prior measurement systems have attempted to address some of these needs. For example, the user may be supplied with the source code for the standard tasks and allowed to modify and recompile the code. This has several limitations. Firstly, the user must be instructed on how to make the modifications and recompile the code. Secondly, the user must purchase the tools to do this. Thirdly, the user may introduce errors in the code for the standard task, which increases the amount of technical support required by the user. Fourthly, any proprietary methods contained within the source code for the standard task will be disclosed.

In a variation of this approach, the standard task is separated into a number of smaller tasks or steps. Each step is implement by a ‘chunk’ of code. The user does not modify any of the standard chunks of code, but writes additional code that utilizes the standard chunks of code. The user may be provided with a description of the interface to each chunk of code. An example of this approach is a ‘block diagram’ or ‘visual’ design tool, in which each step is implemented as an independent block. The blocks may have parameter and data interfaces and may be linked together. The user may be provided with a template to develop his, or her, own blocks. This approach can reduce the likelihood of a standard code chunk being modified in error, and does not necessitate the release of source code for the standard blocks. However, each chunk represents a step in a standard process, and the chunks must be linked together in a framework. This requires that the user understand the behavior of each of the many chunks, and so generates a requirement for extensive documentation. This documentation may reveal proprietary methods. In addition the approach still permits the overall process to be modified in error if the framework is modified. As a consequence, the measurement may be invalidated and there is still a need for significant technical support from the supplier.

A further approach is the use of a ‘plug-in’ code module. A plug-in code module is code that interacts with an application to provide specialized data processing. For example, web browsers have plug-in code modules for receiving streamed audio and visual data and presenting it to a user. Audio processing and graphics programs have plug-in code modules called filters, which allow data to be manipulated (transformed) in a custom manner and passed back to the program. This feature allows third party vendors and users to add additional features to widely used applications. However, the use of plug-in code modules has been restricted to custom data manipulation; they do not allow the user to modify the operation of the program.

A further approach is the use of inheritance in which objects or components are provided for standard subtasks, and the user can use these as a basis for defining more complex processes.

A still further approach is parameterization, in which the user is provided with an interface and may adjust parameter values or select between alternative subtasks. However, this approach does not provide a capability for the user to add new sub tasks.

A still further approach is the use of templates or code generators; however, these have the same limitation as block diagram tasks described above.

In view of the above, there is an unmet need for a method that allows a user to:

1. modify selective behavior of the process,

2. modify data at selected points within in the process, and

3. add additional functionality;

while at the same time:

1. not disclosing proprietary source code,

2. not requiring documentation of the whole process, and

3. preventing the user from invalidating the process.

### SUMMARY OF THE INVENTION

The invention provides a method by which a user can modify or interact with a software process at one or more specified points within the code. These points are called variation points and are inserted by the designer at points in the code where a designer anticipates that a user may want to interact with or modify the process. In operation, when a variation point is reached, control passes to a user-defined process or subsystem. The user-defined subsystem performs one or more actions, including modification of measurement data, control of a device being tested and variation of numerical and control parameters defining the measurement process. Control may then be passed back to the measurement process. Subsequent operations performed by the measurement process may be affected through the numerical and control parameters.

### BRIEF DESCRIPTION OF THE DRAWINGS

The novel features believed characteristic of the invention are set forth in the claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a diagrammatic representation of a measurement system,

FIG. 2 is a sequence diagram for one embodiment of the invention, and

FIG. 3 is a graphical representation of the structure of a computer program in accordance with one embodiment of the invention.

FIG. 4 is a flow chart depicting the method by which a user of the measurement process can cause a variation in the measurement process in accordance with one embodiment of the invention.

### DESCRIPTION OF THE INVENTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several Views of the drawings.

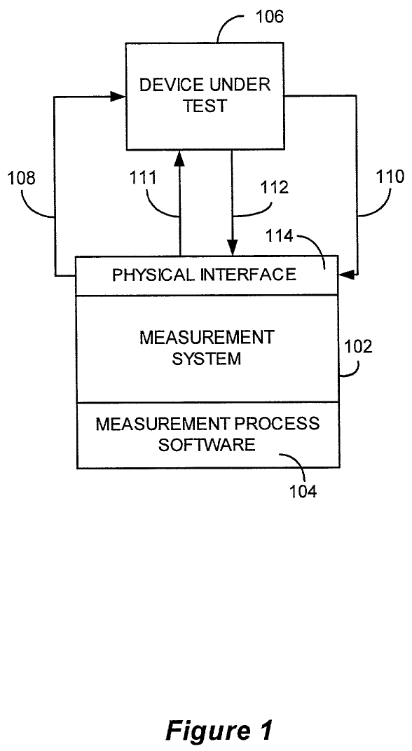

Measurement and test equipment are utilized in many applications. A diagrammatic representation depicting the use of a measurement system is shown in FIG. 1. Referring to FIG. 1, the measurement system 102 includes measurement process software or code 104, stored in a computer readable medium, and a physical interface 114. Additional interface components (not shown) may also be used. The physical interface 114 functions to connect the measurement system 102 to a device under test 106. Through the physical interface 114, the measurement system 102 may provide signals 108 that control the inputs to the device under test 106, and signals 111 that control the configuration of the device under test. The measurement system receives output signals 110 that indicate the properties or behavior of the device under test, and signals 112 that indicate the configuration of the device under test. The output signals 110 may be provided by detectors, such as sensors or probes.

The measurement process software 104 operates to control the measurement system, including sequencing of input and output, control of configuration and analysis of data.

An example of where sophisticated measurement equipment is used is the testing of telecommunications devices such as cellular handsets or optical multiplexers. These devices are highly complex and have many modes of operation. Consequently, complex measurement equipment is required to verify that the devices operate according to their specifications. The test equipment must generate a variety of test signals and analyze the responses to those signals. With devices of such complexity, it is often not practical for a user to understand the detailed operation of the measurement equipment. However, the user may still wish to modify or customize certain portions of the measurement process to add addition functionality to the process.

The invention provides a method by which a user of the measurement system can modify or interact with the measurement process at one or more specified points within the measurement process software. These points are called variation points and are inserted by the designer at points in the code where the designer anticipates that a user may want to interact with or modify the process.

In operation, when a variation point is reached, control passes to a user-defined process or subsystem. The user-defined subsystem performs one or more actions, including modification of measurement data, control of the device being tested and variation of numerical and control parameters defining the measurement process. Control may then be passed back to the measurement system. Subsequent operations performed by the measurement system may be affected through the numerical and control parameters.

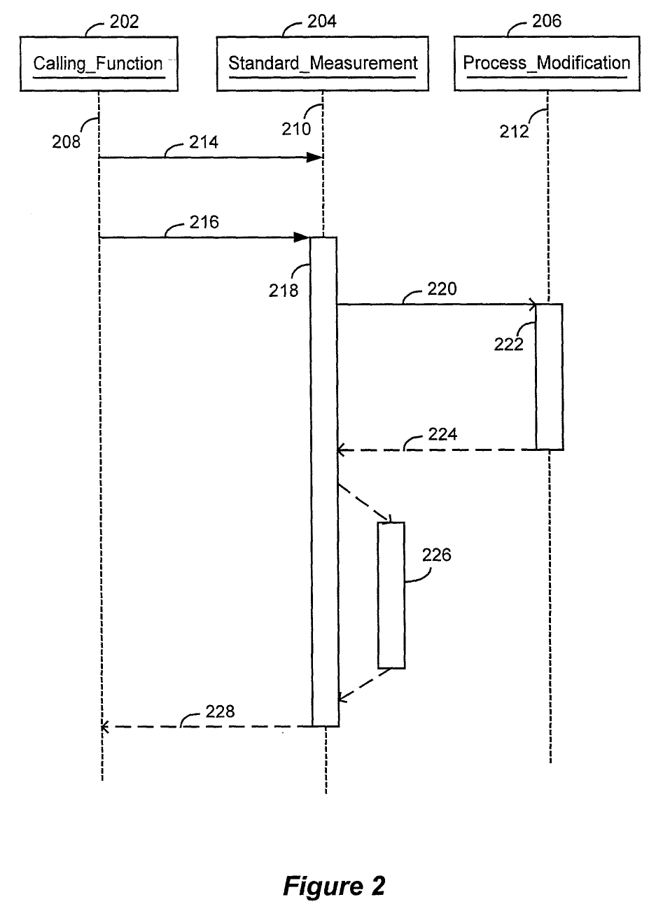

FIG. 2 is a sequence diagram for one embodiment of the method of the invention. In the diagram, the downward vertical direction indicates advancing time, while each vertical column represents an instance of a process or a module. In the simple exemplary embodiment depicted in FIG. 2, there are three processes, namely, calling function 202, standard measurement process 204 and process modification module 206. The sequence is started by the calling function 202. The time line of the calling function is denoted by the vertical broken line 208, the time line of the standard measurement process is denoted by 210 and the time line of the process modification module is denoted by 212. It is to be understood that the time lines shown relate to the modification of the measurement process, and that many other operations are typically performed in a measurement process. The arrow 214 denotes a call from the calling function to the standard measurement process to register the interface of the process modification module with a function named make_variation in the measurement process. This may take the form, for example, of the function call

register_variation(interface:Process_Modification)

In this embodiment, this indicates that when the variation point is reached, the interface should be serviced by a function within the Process_Modification module.

The arrow 216, denotes invocation of the standard measurement process, and may take the form of the function call

run( ).

The duration of the standard measurement process is denoted by the block 218.

At some point in the standard measurement process, a variation point is reached and, as indicated by the arrow 220, control is transferred to the Process_Modification module. Parameters are passed using the interface registered at 214. The call may take the form

make_variation(variationID:String, data:String).

In this example, the arguments of the make_variation function comprise an identification string and a data string. However, other types of parameters may be used. The data string may contain measurement data, numerical parameters and control parameters. The duration of the Process_Modification module is indicated by the block 222. After the appropriate modifying action has been taken, control returns to the measurement process as indicated by the arrow 224. Any element of the data string may be changed, and passed back to the measurement process. The portion of the measurement process subsequent to 224 may thus be modified. For example, alternative process 226 may be implemented rather a portion of the block 218, dependent upon a parameter set by the variation function.

Finally, when the measurement process 218 is completed, control is returned to the calling function, as indicated by the arrow 228.

In general, multiple variation points are inserted into the code for the measurement process. In one embodiment, each variation point is associated with an identifier and each identifier is associated with a process modification function, ensuring that the appropriate modification action will be taken. In a further embodiment, each variation point is associated with a function name, e.g. make_variation1, make_variation2, . . . etc. The user may provide functions with the appropriate names, which are dynamically linked with the measurement code when it is loaded.

Each variation point can use a separate interface or each variation point can use the same interface with a marker or parameter or key.

In this example, interaction between the measurement system 102 in FIG. 1 and the device under test has not been shown. The process modification module may interact with the device under test. In one embodiment, this interaction is made independent of the measurement system. In a further embodiment the physical interface of the measurement system is used to facilitate the interaction. In a still further embodiment, components of the measurement process are utilized to interact with the device under test.

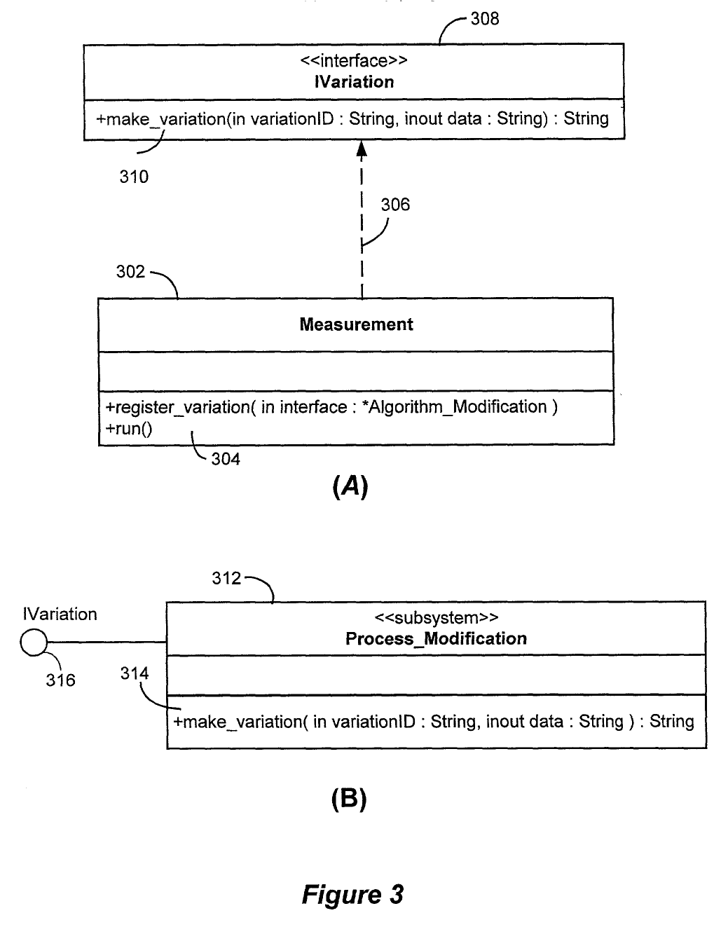

In the example described above, the standard (unmodified) measurement process is realized by a single software system. FIG. 3(A) is a simplified UML (Unified Modeling Language) class diagram showing the software classes associated with measurement system 302. The class diagram is a graphical representation of the structure of the code associated with the modification process. Internal to the measurement system are a number of functions 304. These include the function

+register_variation(in

interface:*Process_Modification)

which indicates that the call to the function make_variation in the measurement process should be serviced by the corresponding function in the interface of the modifying module Process_Modification, and the function

+run( )

which invokes the measurement process, and has no calling arguments. In the UML, the symbol ‘+’ is used to denote that the function is accessible outside of the class, i.e. that it is a public function.

The arrow 306 denotes a realization relationship between the measurement system 302 and an interface named IVariation, 308. This indicates that the interface is realized by the measurement system. The interface includes a function 310 that returns a string value, as indicated by the notation “: String”. The function has two inputs, an identifier string variationID and a data string data. The data string is also an output since it can be modified by the process modification component. Alternatively, the variation can be made through a value returned by the function.

FIG. 3(B) is a simplified UML class diagram showing the software classes associated with process modification subsystem 312. The subsystem includes a function make_variation 314 that returns a string.

The register_variation function call determines that this is the function to be used to service the function call at the variation point. The process modification subsystem 312 supports the interface 316, which indicates that the process modification subsystem is called using the interface IVariation.

If more than one process modification functions are to be used, the calling arguments in 310 and 314 include a variation point identifier, variationID, so that the process modification subsystem can select action appropriate to the variation point at which the call was made.

The interaction between the measurement process and the process modification module is determined by the interface. In one embodiment, the interface is specified at a binary (bit) level. The process modification module may be written in any computer language and run on any computer provided that it supports the interface.

A variety of methods for performing the call-out to the process modification module will be apparent to those skilled in the art. For example, in one embodiment, the process modification module is provided as a dynamically linked library (DLL) of functions that runs on the same computer and in the same memory space as the measurement process. The module could alternatively be provided as a run-time DLL that runs on the same computer but in a separate memory space. As further options, Connection Point Interfaces (Visual Basic Events) or an Event Server could be used as an interface mechanism.

A Component Framework may be utilized, which supports the creation of runtime instances of Components, and provides services for Components to be discovered, communicate, persist, etc. For example, the process modification component may be provided as a Component Object Module (COM) DLL file or as a COM executable file that runs on the same computer but in a memory space separate from the measurement process. The measurement process may instantiate a predetermined COM interface definition and binary data specification. Alternatively, the measurement process may invoke one or more COM interfaces passed into the measurement process.

Similarly, the Common Object Request Broker Architecture (CORBA) provides a set of specifications that define a central inter-component communication mechanism and a set of service components to provide common services. The call-out may use one or more CORBA-based servers. This provides the additional functionality of allowing the process modification component to run on a separate computer, which may be remote from the measurement system and connected to it via a network.

The process modification module may be implemented as an Enterprise Java Bean (EJB).

The invocation of the process modification module and the associated parameter passing may be implemented using Simple Object Access Protocol (SOAP), which is an XML-based format for specifying method invocations between computer systems (XML or extensible Markup Language is a language for facilitating communication between Components). SOAP is completely independent of any platform, operating system or programming language and can easily be used over the Internet with the widely used HTTP protocol. Microsoft web service could similarly be used as the interface mechanism.

Other methods for performing the call-out to the process modification module will be apparent to those of ordinary skill in the art.

Use of the above techniques allows the user to develop the process modification module using a computer architecture and computer language of their choice.

The process modification module may interact with the measurement process in various ways. It can perform additional operations or transforms on the data. This can include modification of data sent to the device under test, modification of the data received from the device under test or modification of data derived from that received. In addition, it can modify the measurement procedure by modifying numerical parameters and by modifying control parameters. The control parameters are used to determine subsequent flow through the measurement process or to determine options or alternatives.

The process modification component can pass instruction codes to send to the device under test or to other instruments.

The process modification component can interact with the device under test to alter its configuration.

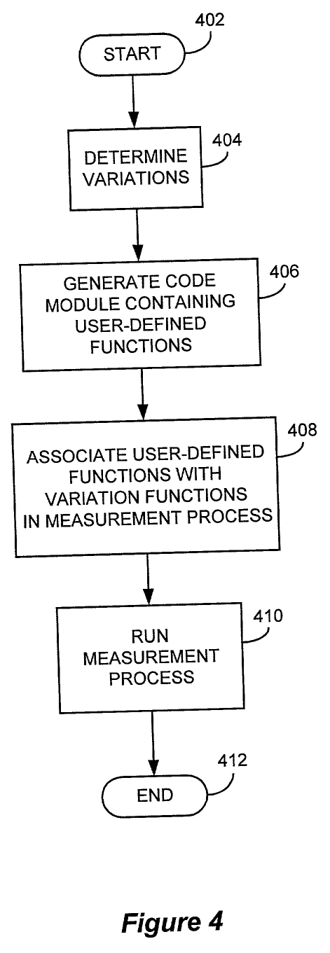

A flow chart depicting the method by which a user of the measurement process can cause a variation in the measurement process is shown in FIG. 4. Referring to FIG. 4, the method starts at start block 402. At block 404 the user determines what variations to the measurement process are desired. These variations preferably takes place at variation points within the measurement process, as determined by the designer of the measurement process, thereby preventing the user from invalidating the measurement. At block 406, the user generates at least one code module containing functions defined by the user. The code module may be written by the user, constructed from existing components or produced by editing a code template. The user-defined functions are designed to cause the desired variations. At block 408 the user-defined functions are associated with the variation functions called at the variation points within the measurement process, in order that control is passed to the appropriate user-defined function when the variation point is reached. For example, this step may require simply placing the code module in a predetermined directory on the computer or registering the functions (or an interface including the functions) with an operating system. At block 410 the measurement process is executed. When the measurement process reaches a variation point, the user-defined function associated with that variation point is called, thereby allowing the measurement process to be varied. The method ends at termination block 412.

While the invention has been particularly shown and described with reference to a preferred embodiment, it will be understood by those skilled in the art that various changes in form and detail may be made therein without departing from the spirit and scope of the invention.

What is claimed is:

1. A method for a user of a measurement process to cause a variation in the measurement process, the measurement process comprising a sequence of operations controlled by a computer program containing a variation point at which control is passed to a variation function, said method comprising:
determining the variation to the measurement process;
providing a process modification software module comprising a user-defined function for causing the variation; and
associating the user-defined function with the variation function, wherein control is passed to the user-defined function when the variation point in the computer program is reached.

2. A method as in claim 1, wherein the process modification software module further comprises an interface servicing element that services an interface realized by the measurement process.

3. A method as in claim 2, wherein said interface operates in accordance with a predetermined protocol.

4. A method as in claim 3, wherein said predetermined protocol is specified at a binary level.

5. A method as in claim 3, wherein said predetermined protocol is a Simple Object Access Protocol.

6. A method as in claim 3, wherein said predetermined protocol is a Common Object Request Broker Architecture.

7. A method as in claim 2, wherein said interface is determined by the user and is passed into said measurement process.

8. A method as in claim 1, wherein said process modification software module is one of a Component Object Module, an Enterprise Java Bean, and a Dynamically Linked Library.

9. A method as in claim 1, wherein the measurement process and the process modification software module are executed in a shared computer memory space.

10. A method as in claim 1, wherein said measurement process is executed in a first memory space of a first computer and said process modification software module is executed in a second memory space which is distinct from the first memory space.

11. A method as in claim 10, wherein the second memory space is located within a second computer.

12. A method as in claim 11, wherein the second computer is remote from the first computer.

13. A method as in claim 12, wherein the first computer and the second computer communicate via a network.

14. A method as in claim 1, wherein said variation comprises modification of data.

15. A method as in claim 1, wherein said variation comprises modification of one or more numerical parameters of the measurement process.

16. A method as in claim 1, wherein said variation comprises modification of one or more control parameters of the measurement process, wherein one or more alternatives within the measurement process may be selected.

17. A method as in claim 1, wherein said measurement process is applied to a device under test and said variation comprises alteration of a configuration of the device under test.

18. A method as in claim 1, wherein said measurement process is applied to a device under test and said variation comprises causing input signals to be supplied to the device under test.

19. A method as in claim 1, wherein said computer program contains a plurality of variation points and said process modification software module comprises a plurality of user-defined functions and wherein each of the plurality of variation points is associated with one of the plurality of user-defined functions.

20. A method as in claim 1, wherein said computer program contains a plurality of variation points and a plurality of process modification software modules are provided, each of the plurality of process modification software modules comprising at least one user-defined function and wherein each of the plurality of variation points is associated with one of the at least one user-defined functions.

21. A computer readable medium containing instructions which, when executed on a computer, control a measurement process, said instructions comprising:
a plurality of instructions operable to control the measurement process; and
a function call instruction operable to pass control to a variation function;
wherein the variation function operates to modify the measurement process.

22. A computer readable medium as in claim 21, wherein the function call instruction is operable to pass parameters to the variation function.

23. A computer readable medium as in claim 22, wherein the parameters comprise measurement data.

24. A computer readable medium as in claim 21, wherein the function call instruction is operable to receive parameters from the variation function.

25. A computer readable medium as in claim 26, wherein the parameters comprise control parameters, operable to select between a plurality of alternative instructions controlling the measurement process.

26. A computer readable medium as in claim 24, wherein the parameters comprise numerical parameters, operable to modify the measurement process.

27. A computer readable medium as in claim 24, wherein said measurement process is applied to a device under test and wherein the parameters comprise control codes, operable to cause signals to be supplied to the device under test.

28. A computer readable medium as in claim 24, wherein said measurement process is applied to a device under test and wherein the parameters comprise control codes, operable to alter the configuration of the device under test.

29. A computer readable medium as in claim 21, wherein the function call instruction invokes an interface.

30. A computer readable medium as in claim 21, wherein the variation function is provided by a user of the measurement process, thereby allowing the user to modify the measurement process.

31. A computer readable medium as in claim 30, wherein the variation function provided by the user of the measurement is accessed via an interface.

32. A computer readable medium as in claim 31, wherein said interface operates according to a predetermined protocol.

33. A computer readable medium as in claim 32, wherein said predetermined protocol is specified at a binary level.

34. A computer readable medium as in claim 33, wherein said predetermined protocol is a Simple Object Access Protocol.

35. A computer readable medium as in claim 33, wherein said predetermined protocol is a Common Object Request Broker Architecture.

36. A computer readable medium as in claim 31, wherein said interface determined by the user and wherein said instructions further comprise instructions to identify the interface.

37. A computer readable medium as in claim 21, wherein said variation function is implemented as one of a Component Object Module, an Enterprise Java Bean, and a Dynamically Linked Library.

38. A computer readable medium as in claim 21, further comprising a plurality of function call instructions passing control to a plurality of variation functions.

39. A computer readable medium as in claim 21, wherein said function call instruction is placed within said plurality of instructions operable to control the measurement process at a variation point where a designer of the instruction anticipates a user may want to interact with or modify the measurement process.
